(19) United States
(12) Patent Application Publication
(10) Pub. No.: US 2006/0151594 A1
(43) Pub. Date: Jul. 13, 2006

(54) Compound time recording device

(76) Inventor: Chang Ching Hsien, Jhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/030,112

(22) Filed: Jan. 7, 2005

(51) Int. Cl. G06K 7/10

(52) U.S. Cl. 235/377

(57) ABSTRACT

A compound time recording device includes a time recorder, a recording card, a radio frequency identification attached to the recording card, a reader for detecting and receiving a signal carrying card-associated data from the radio frequency identification, and a transmission interface. The time recorder includes a printing device that makes selective printings of time data on the recording card. The transmission interface selectively couples the time recorder to a computer system by a cable or via a network. Data retrieved from the radio frequency identification by the reader is applied to transmission interface through which the data are transmitted to the computer for data collection and statistics and for facilitating management and on-line, real-time monitoring.

### BACKGROUND OF THE INVENTION

1. Field of the Invention

The present invention generally relates to the time recorder for recording employee's sign-in and sign-out time by printing on a recording card, and in particular to a compound time recording device that combines card-printing and radio frequency identification having memory for storage of the time data together to facilitate recording, transmission, and personnel management.

2. The Related Art

A time recorder is often employed to record the sign-in and sign-out time of an employee by making printing of the associated time data on a card board. Conventional time recorder comprises a timer, which is either an analog hand type clock, or a digital clock having a liquid crystal display. Conventionally, time data printed on the recording card must be collected and summarized manually from each recording card. Human error often occurs in doing statistics of these time data, especially when there are a great number of recording cards. Also, the printings that are made on particular columns of the recording card may severely shift whereby it becomes hard to identify the time recorded. All these lead to difficult of statistics, management and personnel control.

In addition, the conventional time recorder is a site-based device, which only allows for data collection and statistics for a branch of a company at a particular site. Other branches that are located at different sites must have their own time recorder and do their own statistics of time data. The result of statistics of different branch is then combined later. This is troublesome and low efficiency, and requires a great amount of labor and time to complete the statistics. On-line and real-time monitoring and time-efficient computerized statistics are not possible.

Taiwan Patent Publication No. 540770, which relates to an improvement over time recorder, teaches to install a barcode reader in the time recorder for reading barcode printed on a recording card. The barcode reader operates with light beam, which requires the barcode to be positioned close to the barcode reader in order to perform reading of the barcode information. This imposes undesired limitation to the use of the barcode reader in the time recorder, for any unacceptable shifting of the barcode with respect to the reader leads to failure of data reading. Further, such a device does not allow for computerized statistics of data.

Taiwan Patent Publication No. 398658 teaches a time recorder that is capable to recognize recording cards of different groups by identifying notches of different depth formed in the recording cards. Again, precise positioning of the recording card in the time recorder is a must for correct identification of the card group. Further, computerized and time-efficient statistic of time data cannot be achieved by this conventional device.

Thus, it is desired to have a time recorder that allows for time-efficient and human error free statistics of time data, on-line and real-time monitoring, and remote accessibility in order to overcome the drawbacks of the conventional devices.

### SUMMARY OF THE INVENTION

An objective of the present invention is to provide a compound time recorder comprising a radio frequency identification attached to a recording card and an associated reader installed in the time recorder to detect a signal from the radio frequency identification for receiving data stored in the radio frequency identification, which allows for data reading without precisely positioning the recording card with respect to the time recorder.

Another objective of the present invention is to provide a compound time recorder comprising a transmission interface that allows for connection with and data transmission to an external computer system via a cable or a network or wireless data communication so that collection and statistics of time data of recording cards can be performed in a time-efficient, computerized manner and on-line, real-time monitoring can be realize.

To achieve the above objectives, in accordance with the present invention, a compound time recording device is provided, comprising a time recorder, a recording card, a radio frequency identification attached to the recording card, a reader for detecting and receiving a signal carrying card-associated data from the radio frequency identification, and a transmission interface. The time recorder comprises a printing device that makes selective printings of time data on the recording card. The transmission interface selectively couples the time recorder to a computer system by a cable or via a network. Data retrieved from the radio frequency identification by the reader is applied to transmission interface through which the data are transmitted to the computer for data collection and statistics and for facilitating management and on-line, real-time monitoring.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a compound time recording device in accordance with the present invention;

FIG. 2 is a system block diagram of the compound time recording device of the present invention;

FIG. 3 is a schematic view showing the compound time recording device of the present invention linked to a personal computer;

FIG. 4 is a schematic view showing the compound time recording device of the present invention linked to a remote computer system;

FIG. 5 shows a compound time recording device in accordance with a second embodiment of the present invention; and

FIG. 6 shows a compound time recording device in accordance with a third embodiment of the present invention.

### DETAILED DESCRIPTION OF THE PREFERRED EMBODIMENT

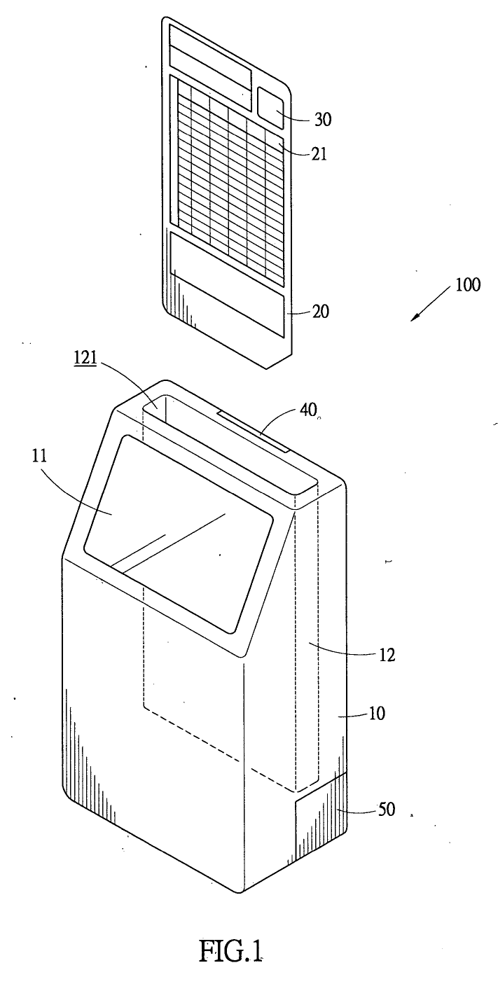

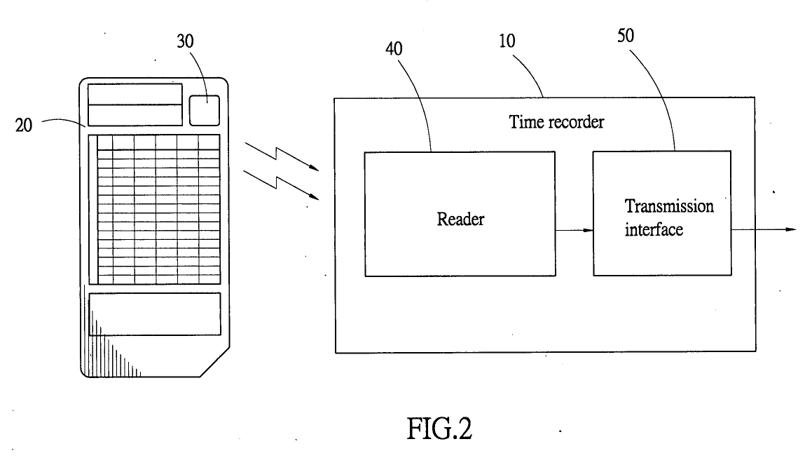

With reference to the drawings and in particular to FIGS. 1 and 2, a compound time recording device constructed in accordance with the present invention, generally designated with reference numeral 100, comprises a time recorder 10, which is of any known type, such as an analog hand type and a digital liquid crystal display (LCD) type. In the embodiment illustrated herein, the timer recorder 10 is an LCD time recorder. However, it is obvious to those having ordinary skills to employ the principle of the present invention, which will be described in detail hereinafter, to an analog hand type time recorder. Thus, the timer recorder 10 comprises a liquid crystal display 11, which shows time and card printing status. The time recorder 10 also comprises a printing device 12 housed in a casing (not labeled) of the time recorder 10. The casing of the time recorder 10 defines a top opening 121 for the entry of a recording card 20, such as an employee sign-in card.

The recording card 20 has a major surface on which a plurality of record columns 21 is printed. Once the recording card 20 is inserted into the top opening 121 of the time recorder 10, the printing device 12 is actuated to make printing on proper ones of the columns 21. This is well known and no further detail is needed.

A radio frequency (RF) identification 30 is attached to the recording card 20 at any suitable locations. In the embodiment illustrated, the RF identification 30 is located at an up-right corner of the recording card 20, which is of a rectangular shape. Further, the RF identification 30 can be attached to the recording card 20 with any suitable manner, such as by adhesives, which is illustratively employed in the embodiment illustrated. The RF identification 30 comprises memory means that stores an identification code and recorded data that is associated with the specific card 20. In the embodiment illustrated, the RF identification 30 is made in the form of a chip attached by adhesives to the recording card 20. However, the RF identification 30 can be made of any other types of devices. The RF identification 30 also comprises a transmitter that selectively transmits an RF signal carrying information associated with the recording card 20, including the identification code and the data stored in the memory means, which will be referred to as card-associated information for simplicity.

A reader 40, which comprises an RF receiver, is housed in the casing of the time recorder 10 and can be arranged at any suitable location, such as along a back panel of the casing of the time recorder 10 and behind the top opening 121 as illustrated in the drawings. When the RF identification 30 is approaching the reader 40 within a predetermined distance, the reader 40 detects the signal from the RF identification 30 and reads the card-associated information stored in the RD identification 30, as well as other information, if desired. The reader 40 also functions to convert and output the card-associated information, including the identification code and the recorded data of the RF identification 30, to the printing device 12 by which the data may be printed on the recording card 20.

A transmission interface 50, also housed in the casing of the time recorder 10, is coupled to the reader 40 for transmitting the card-associated information from the reader 40 to an external device (not shown). An example of the interface 50 includes a USB (universal serial bus) interface. Other standard interface, such as RS-232, may also be employed.

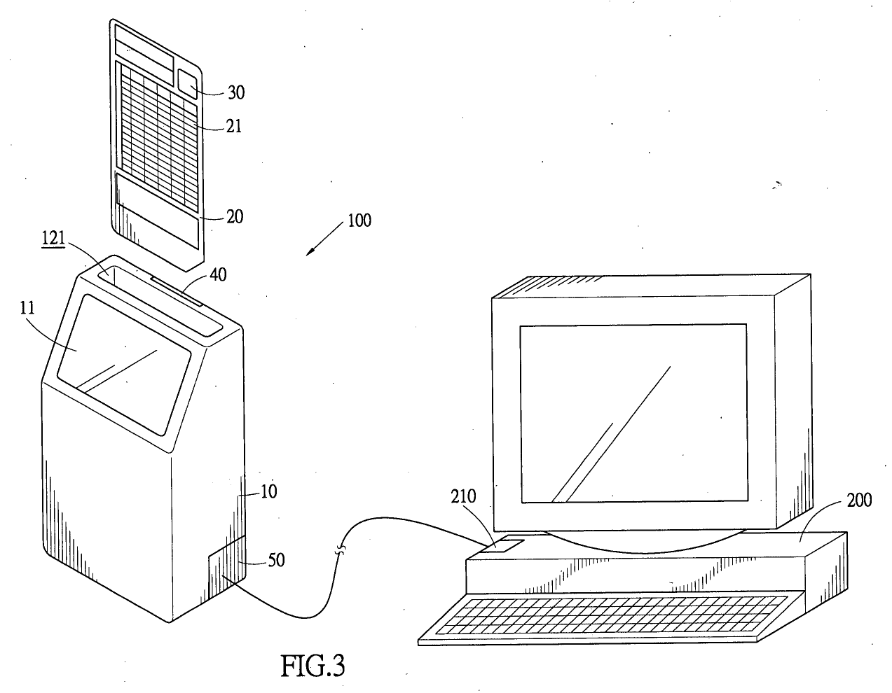

Also referring to FIG. 3, the compound time recording device 100 can be selectively coupled to a local computer 200 via the interface 50. A USB cable 51 having an end connected to a USB interface 210 of the computer 200 is coupled to the transmission interface 50 of the time recorder 10. This allows the time recorder 10 to transmit the card-associated information received from the RF identification 30 of the recording card 20 to the computer 200 for the purposes of statistics, management, and real-time monitoring.

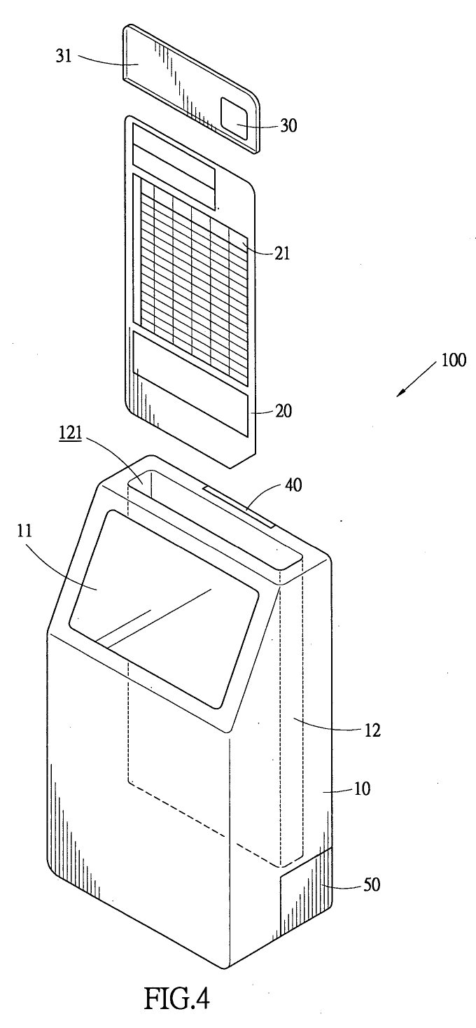

Also referring to FIG. 4, an application of the time recording device 100 of the present invention in a networked environment is illustrated. The transmission interface 50 may further comprise a data communication interface, which allows for connection with a network 300, such as the Internet or a local network, via for example a telephone line 52, to establish communication connection with a remote computer system 400. In this application, a single computer system 400 can be connected to a number of time recording devices 100 to simultaneously receive data from the time recording devices 100 for the purposes of statistics, management, and on-line monitoring.

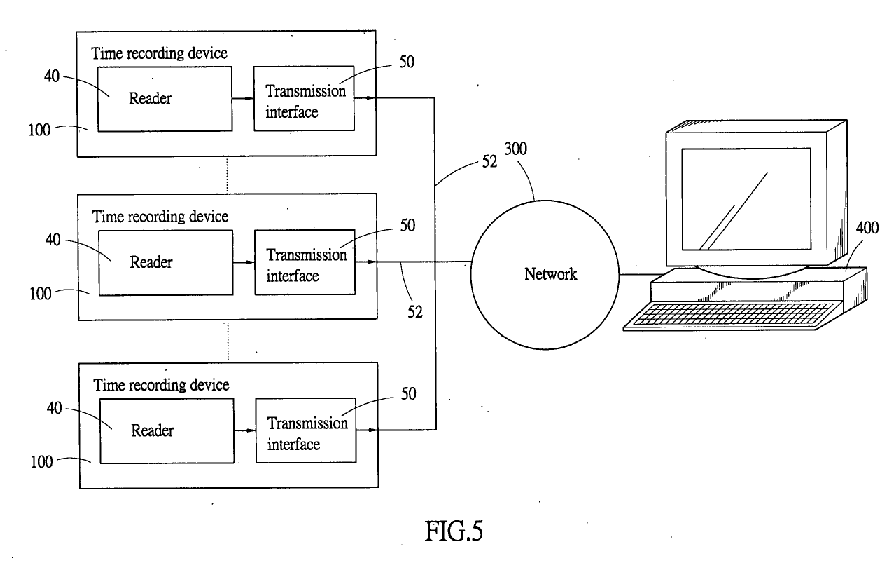

Also referring to FIG. 5, the RF identification 30 can be attached to the recording card 20 in a different manner, such as a second embodiment illustrated in FIG. 5, also designated with reference numeral 100 for simplicity. In the second embodiment illustrated, most parts and construction are similar to those of the embodiment illustrated with reference to FIGS. 1-3, which are labeled with the same reference numerals and will not be further discussed for simplicity. The difference between the first and second embodiments resides in that, rather than directly attached to the recording card 20 by adhesives illustrated in the first embodiment, the RF identification 30 of the second embodiment is formed on or mounted to a removable cover 30 that is selectively fit over a top end of the recording card 20. This allows the RF identification 30 to be used independently or in combination with the recording card 20.

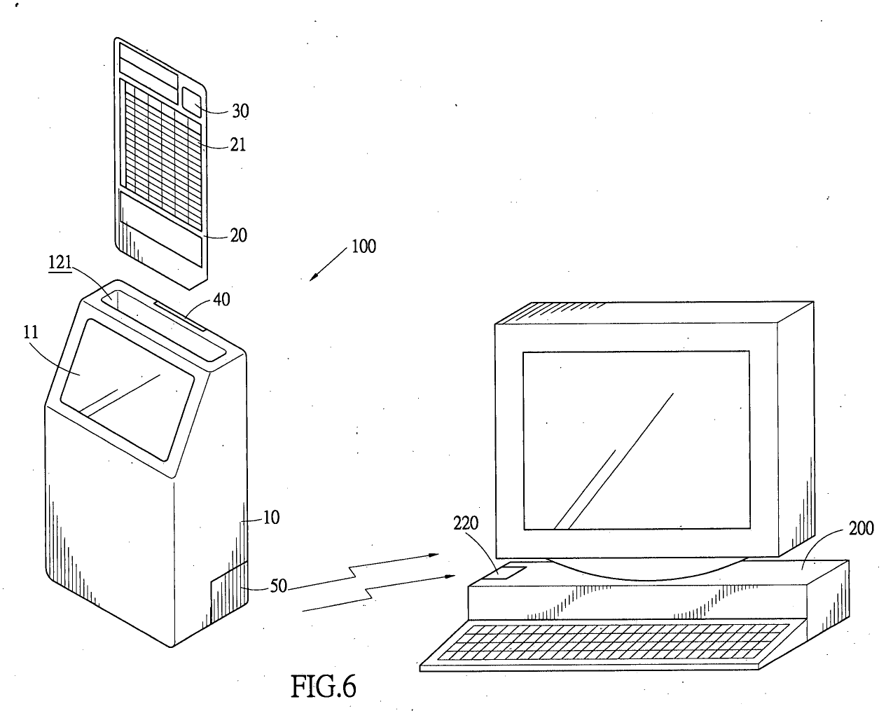

If desired, the connection between the time recording device 100 with the computer 200 that is realized by a cable 51 in the first embodiment may be alternatively realized by radio frequency transmission, or other wireless communication devices. This is illustrated in a third embodiment shown in FIG. 6, wherein the transmission interface 50 comprises a wireless transmission interface, such as a USB wireless transmission interface, which transmits signals to a wireless receivers 220, a USB receiver in this case, installed in the computer 200. Thus, data can be transmitted in a wireless manner between the time recording device 100 and the computer 200. Physical limitation imposed by the cable 51 is eliminated.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A compound time recording device comprising:
a time recorder comprising a printing device;
a recording card on which printing is made by the printing device;
a radio frequency identification attached to the recording card and comprising means for storing card-associated information including identification code and data associated with the recording card;
a reader coupled to the time recorder to detect and receive a signal carrying the card-associated information transmitted from the radio frequency identification and applying the information to the printing device by which the card-associated information is printed on the recording card; and
a transmission interface coupled to the reader to convert and output the card-associated information to an external device.

2. The compound time recording device as claimed in claim 1, wherein the time recorder comprises a liquid crystal display.

3. The compound time recording device as claimed in claim 1, wherein the time recorder comprises a casing defining a top opening for the entry of the recording card.

4. The compound time recording device as claimed in claim 1, wherein the recording card has a major surface on which columns for recording data are formed.

5. The compound time recording device as claimed in claim 1 further comprising a removable cover selectively fit over the recording card, the radio frequency identification being attached to the removable cover.

6. The compound time recording device as claimed in claim 1, wherein the external device comprises a local computer system to which the transmission interface is coupled.

7. The compound time recording device as claimed in claim 1, wherein the external device comprises a remote computer system to which the transmission interface is coupled via a network.

8. The compound time recording device as claimed in claim 1, wherein the transmission interface comprises a USB interface.

9. The compound time recording device as claimed in claim 1, wherein the transmission interface comprises an RS-232 interface.

10. The compound time recording device as claimed in claim 1, wherein the transmission interface comprises a data communication interface.

11. The compound time recording device as claimed in claim 1, wherein the transmission interface comprises a wireless communication interface.
